(19) United States
(12) Patent Application Publication
(10) Pub. No.: US 2009/0095693 A1
(43) Pub. Date: Apr. 16, 2009

(54) Concentrator System and Method of Water Filtration and Recycling to Drive Industrial Fabrication Process

(76) Inventor: Ross E. Perry, Exeter, NH (US)

Correspondence Address: QUARLES & BRADY LLP, 411 E. WISCONSIN AVENUE, SUITE 2040, MILWAUKEE, WI, 53202-4497, US

(21) Appl. No.: 12/252,135

(22) Filed: Oct. 15, 2008

Related U.S. Application Data
(60) Provisional application No. 60/980,065, filed on Oct. 15, 2007.

(51) Int. Cl. B01D 33/74; B01D 37/00; B01D 33/82; B01D 35/143

(52) U.S. Cl. 210/780; 210/167.01; 210/195.1; 210/350; 210/167.31; 210/86

(57) ABSTRACT

A concentrator for removing particulate matter from waste water is disclosed. The concentrator comprises a frame and a high volume compressible filter supported by the frame. The high volume compressible filter is connected to receive the waste water and permit at least some of the waste water to pass therethrough to remove a portion of the particulate from the waste water. The concentrator further comprises at least one compression arm connected to the frame and configured to engage the high volume compressible filter to agitate the waste water within the high volume compressible filter and force waste water from the high volume compressible filter. The concentrator is configured for use with industrial fabrication equipment such as stone and glass processing and water recycling systems.

### CROSS REFERENCE TO RELATED APPLICATION

This application claims the benefit of U.S. Provisional Patent Application No. 60/980,065 filed Oct. 15, 2007, the disclosure of which is hereby incorporated by reference.

### STATEMENT CONCERNING FEDERALLY SPONSORED RESEARCH OR DEVELOPMENT

Not applicable.

### FIELD OF THE INVENTION

The present invention is directed to a method and system for water treatment and, in particular, to a method and system for filtering particulate matter from waste water to provide clear water and gray water to drive an industrial fabrication process. The present invention is suitable for use with processes such as stone and glass fabrication processes and also addresses the substantial elimination of any waste water discharge to an on-site septic facility, a privately owned treatment works (POTW), or a city sewer.

### BACKGROUND OF THE INVENTION

Water is employed in a wide range of industrial fabrication processes for a wide range of purposes. For example, the stone and glass fabrication industries use water in processes such as cutting, shaping, and polishing. In these cases, water may be used to cool, lubricate, or otherwise drive such processes. Hence, within such industrial fabrication processes, water operates as a consumable that is taken into the process, used for a desired purpose such as listed above, and discharged as waste.

In such industries, the discharge water is consequently referred to as “waste” water and contains particulate waste material. The particulate waste material is primarily comprised of the material being processed, but will often include other particulate material, such as particles from the cutting and polishing tools themselves, polishing or cutting compounds used with the tools and processes, and various other particulate associated with the industrial process.

Often, this waste water is simply discharged or discarded. However, many of these industrial fabrication processes have requirements related to the content and status of the water being discharged. Hence, the waste water may be collected and processed prior to discharge. The type and degree of treatment performed on the waste water depends on the destination of the water.

In some instances, the waste water may be treated in no more than a settling tank to allow at least some of the particulate material to settle out as sediment before the water is returned, for example, to a river or discharged to enter the groundwater possibly through privately owned treatment works (POTWs). Settlement processes generally rely upon the differences in density between the water and the particulate material and gravity to separate one from the other. Some settling systems may also use a flocculent to aid in settling particulate materials or include a torturous path through which the particulate materials must flow using inclined plate clarifiers or the like. In addition, some settling systems also accommodate a collection bag in which particulate materials are further consolidated. However, the particulate materials within the collection bag remain extremely wet and must be replaced frequently. Accordingly, settling methods may be undesirable or insufficient to meet some needs.

For example, water discharged into rivers, streams, groundwater, POTWs, and so on is often required to meet state and federal requirements, which typically require ongoing random testing of the discharged water in compliance with the Clean Water Act or similar acts. In most instances, environmental or health concerns may require removal of the particulate material waste to the level above that achieved by settling methods.

Similarly, in some instances, it may be desirable to recycle or reuse some of the waste water. However, some industrial processes have requirements related to the chemical and physical properties of incoming water, such as acidity, salinity, temperature and so on, and corresponding requirements on discharge water. In addition, often, the principle requirement for input and discharge water concern the particulate or suspended contents of the water rather than, for example, the dissolved contents of the water. This is particularly true in processes related to the stone and glass fabrication industries. Thus, in such industries, specialized treatment processes may be performed on the waste water.

Specifically, waste water may be rigorously processed to remove the waste or particulate from the water. This water is referred to herein as “clear” or “crystal clear” water and is characterized by having no particulate or waste found therein having a cross-sectional distance of greater than 2 microns. On the other hand, waste water may be less rigorously processed to remove some but not all of the waste or particulate from the water. This water is referred to herein as “grey” water and is characterized by having particulate or waste found therein that may include a cross-sectional distance of greater than 2 microns in diameter, yet that is suitable for use in at least some of the industrial processes.

Clear water is used in a number of common industrial processes, such as polishing, CNC processes, and water jets, and the like. In these processes, large particulate material may interfere with the process by creating scratch lines that prevent the desired degree of polish or finish from being attained or may clog the tools. Hence, such “clear water processes” require clear intake water that generally contains no particulate material, except particles that are generally less than 1 or 2 microns in diameter.

Grey water may be suitable in a variety of industrial processes. For example, cutting, drilling and cooling processes may use water containing a moderate amount of particulate material without an adverse affect to the processes or the types of tools used in these processes. However, the specific treatment of recycled grey water depends upon how the grey water is to be used. In some instances, the process may utilize grey water recycled using little more than a settling tank that allows sedimentation of enough of the particulate material that the remaining particulate material in the grey water does not clog the subsequent tools in which it is used. In other situations, substantially more processing may be required to provide grey water with less particulate or waste.

To achieve the desired level of reduced particulate in grey water, some water recycling systems include filters. In general, filtering methods pass the water and particulate matter through some form of trap, clarifier centrifuge, or other media that captures the particles but permits the water to pass through. For example, high-pressure filters such as the filter press are designed to dewater solids that settle in a collection tank. In this process, waste water including the waste particulate material from an industrial process is allowed to stand in a sedimentation tank to allow at least a part of the particulate material to settle out of the water, some with the use of a chemical precipitant. The particulate material settles in the sedimentation tank, which contains a significant proportion of water, and is pumped to the filter press. The filter press essentially removes the water from the sediment by trapping the sediment in the filter press and allowing the recovered water to return to the source through a treatment system. The particulate material collected in the filters of the filter press is occasionally mechanically removed and typically discarded. Filtering methods are typically faster but much more expensive than gravity settling.

A filter press is effective for removing water from particulate material for the reasons described above. However, filter presses have certain disadvantages that become particularly clear when relatively high volumes of filtered water are required, and/or high quantities of particulate matter are to be removed. In order to provide relatively high filtered water flow rates, additional and/or larger filter presses may be added to the system or the filter press may be serviced to remove particulate material more frequently. For example, the filter press may need to be serviced on a daily basis. Further still, an extensive amount of time, for example, two and a half hours or more, may be needed to clean the filter press. As a result, these alternatives add substantially to system and operating costs and reduce productivity of shop personnel.

It should be recognized, therefore, that these limitations on the capacity and flow rate of filter presses are a significant problem in many processing shops in which the required clean water flow volumes must maintain peak flow rates for longer periods of time. In addition, frequent servicing of filter presses may also provide a problem for smaller processing shops due to reduced productivity of shop personnel.

Hence, recycling waste water into grey water having substantially reduced particulate or waste or recycling waste water into clear water can be a complex and expensive process. This is particularly evident in systems that are relatively large or need to accommodate relatively large flow volumes.

Therefore, it would be desirable to have a system and method for recycling large amounts of waste water produced by industrial processes, such as glass and stone fabrication, to provide grey and/or clear water for driving the process.

### SUMMARY OF THE INVENTION

The present invention overcomes the aforementioned drawbacks by providing a multi-level system and method for water treatment and recycling. Specifically, the present invention utilizes a system for collecting waste water and subjecting the collected waste water to a multi-stage filtering and dewatering process that includes a concentrator. The concentrator includes a high-volume compressible filter and at least one compression arm configured to engage the high-volume compressible filter to agitate the high-volume compressible filter and thereby force the waste water from the high-volume compressible filter as grey water while securing particulate suspended in the waste water within the high-volume compressible filter.

In accordance with one aspect of the present invention, a water recycling system is disclosed for providing clear water to processing tools. The system comprises a collection tank connected to receive waste water discharged by industrial fabrication equipment. A high volume compressible filter is connected to receive waste water from the collection tank and permit at least some of the waste water to pass therethrough to remove a portion of particulate from the waste water. At least one compression arm is configured to engage the high volume compressible filter to agitate the waste water within the high volume compressible filter and force waste water from the high volume compressible filter. The system further comprises a clear water supply loop that includes a high pressure filter connected to receive the waste water from the collection tank and convert the waste water to the clear water. A clear water tank is connected to receive and store the clear water from the high pressure filter. A clear water supply pump is connected to receive the clear water from the clear water tank and provide the clear water to the industrial fabrication equipment.

In accordance with another aspect of the present invention, a water recycling system is disclosed that includes a grey water loop supplying water to coarse processing tools and a clear water loop supplying water to fine processing tools. The system comprises a collection tank connected to receive waste water discharged from the grey-water and clear-water processing tools. The system further comprises a clear water tank connected to supply clear water to the clear-water processing tools. A filter press is connected to receive waste water from the collection tank and configured to convert the waste water to clear water and connected to supply clear water to the clear water tank. The system further comprises a grey water supply line connected to provide waste water from the collection tank to the grey-water processing tools, and the grey water supply line is connected in parallel relative to the filter press. The system further comprises a concentrator connected to receive waste water from the collection tank and configured to accommodate a high volume compressible filter configured to remove particulate material from the waste water, and the concentrator is connected in parallel relative to the filter press. The system further comprises a drainage conduit connected to return water from the concentrator to the collection tank after removing the particulate material from the waste water.

In accordance with another aspect of the invention, a method of providing clear water to processing tools is disclosed. The method includes receiving and storing waste water from waste water discharge ports of the processing tools in a collection tank, filtering the waste water from the collection tank in a high pressure filter to produce clear water, receiving and storing the clear water from the high pressure filter in a clear water tank, and providing the clear water from the clear water tank to the processing tools through a clear water supply pump. The method further includes filtering the waste water from the collection tank in parallel relative to the high pressure filter in a high volume compressible filter to remove particulate material, compressing the high volume compressible filter to force water to pass through the high volume compressible filter, and returning water to the collection tank after removing particulate material with the high volume compressible filter.

These and other advantages and aspects of the invention will become apparent from the following description. In the description, reference is made to the accompanying drawings which form a part hereof, and in which there is shown a preferred embodiment of the invention. Such embodiment does not necessarily represent the full scope of the invention and reference is made therefore, to the claims herein for interpreting the scope of the invention.

### BRIEF DESCRIPTION OF THE DRAWINGS

The foregoing and other features and advantages of the present invention will be apparent from the following description of the invention and embodiments thereof, as illustrated in the accompanying figures, wherein:

FIG. 1 is a schematic representation of a water recycling system in accordance with present invention used in conjunction with a stone or glass processing system;

FIG. 2 is a schematic representation of a concentrator of the water recycling system of FIG. 1;

FIG. 3 is a side view of a containment structure of the concentrator of FIG. 2; and

FIG. 4 is a rear view of a containment structure of the concentrator of FIG. 2.

### DETAILED DESCRIPTION OF THE INVENTION

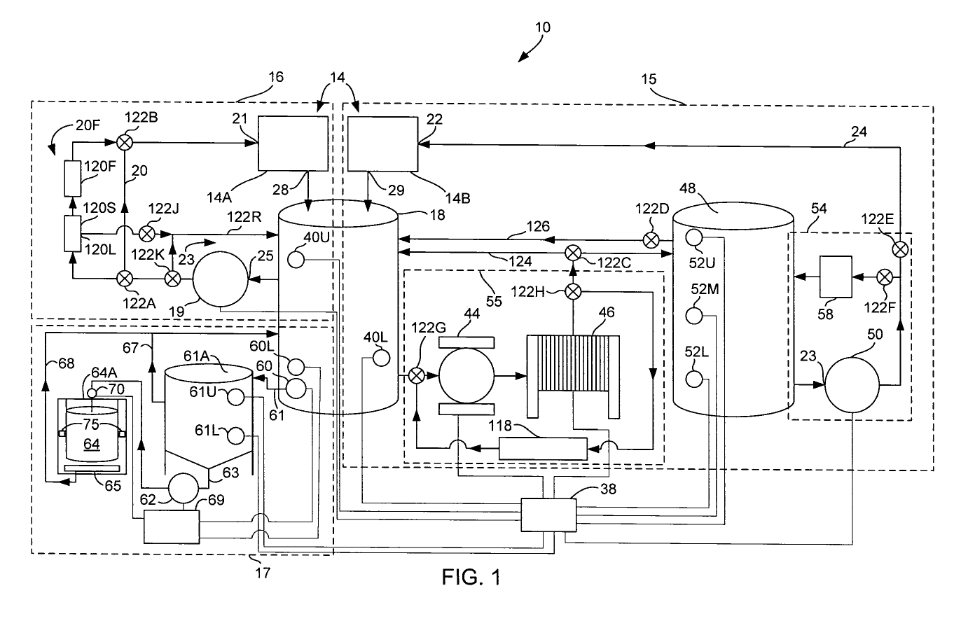

Referring now to the figures and specifically to FIG. 1, a schematic representation is shown of a water recycling system 10 of the present invention used in conjunction with industrial fabrication tools, such as a stone or glass processing tools. In general, the water recycling system 10 is designed to concentrate waste particulate material in a more effective manner and permit a filter press to deliver clear water for longer periods of time between cleaning cycles. The components of the system 10 substantially reduce capital and operating costs and improve overall productivity.

The fabrication system may be a stone or glass processing system that includes processing tools 14, such as grey-water processing tools 14A, which may include bridge and gantry saws, routers, coarse grinders, drilling tools, edging tools, mitering tools, and the like. In addition, it is contemplated that the grey water may be supplied to perform cooling functions (including those of CNC equipment). The processing tools 14 also include clear-water processing tools 14B, which may include hand polishers, surface polishers, edge profilers, edge polishers, water jets, beveling tools, CNC equipment, and the like. As used herein, “grey water” should be understood as water containing particulate material that is typically greater than 2 microns in size, and that is often significantly larger than 2 microns in size. Similarly, as used herein, “clear water” should be understood as water that typically includes only particulate material at most 2 microns in size.

The water recycling system 10 includes a clear water loop 15 that provides clear water for the clear-water processing tools 14B. Similarly, the water recycling system 10 may also include a grey water loop 16 that provides grey water for the grey-water processing tools 14A. The water recycling system 10 further includes a concentrator 17 that removes particulate material from water in the system 10. The grey water loop 16, the clear water loop 15, and the concentrator 17 draw water from a common source in parallel to one another. That is, the loops 15, 16 and the concentrator 17 include independent sets of conduits through which water passes from a collection tank 18. The collection tank 18 may be, for example, a below grade collection pit, an above ground storage tank, and the like. The collection tank 18 may also serve as a sedimentation facility for recycling grey water into clear water.

Referring first to the grey water loop 16, a grey water supply pump 19 drives grey water through a grey water supply line 20 to a grey water input 21 of the grey-water processing tools 14A. The grey water supply pump 19 may be, for example, a self-priming, electrically powered centrifugal pump that delivers grey water at, for example, 40 psi and at the volume required by the grey-water processing tools 14A, which depends on the specific tools included in the stone or glass processing system. After using the grey water in conjunction with a stone or glass fabrication process, the grey-water processing tools 14A discharge the grey water to the collection tank 18 through a waste water discharge port 28 and usually through in-ground trenches or above-ground plumbing lines (not shown). The grey water supply pump 19 returns the grey water in the collection tank 18 to the grey-water processing tools 14A through a pump inlet 25.

The grey water supply pump 19 may be operatively connected to a controller 38 to control the delivery of grey water to the grey-water processing tools 14A. The controller 38 may also operatively connect to an upper collection tank float sensor 40U to control the operation of the grey water supply pump 19 based on the water level in the collection tank 18. Specifically, the upper collection tank float sensor 40U prevents the grey water supply pump 19 from operating if the water level in the collection tank falls below a threshold. The threshold is typically determined by the height at which the pump inlet 25 connects to the collection tank 18. That is, the upper collection tank float sensor 40U is positioned above the connection of the pump inlet 25 to the collection tank 18 so that the grey water supply pump 19 cannot operate in a situation in which air would be pumped instead of water.

The grey water supply pump 19 runs continuously to maintain the desired pressure in the grey water supply line 21 when operation is enabled by the upper collection tank float sensor 40U and the controller 38. Continuous operation of the grey water supply pump 19 ensures a continuous circulation of water through the collection tank 18, which thereby helps to prevent the collection tank 18 from collecting sediments. However, the collection tank 18 may also include a manifold or valve that connects to a flush line 122R of the grey water supply pump 19 to permit sediment accumulated in the collection tank 18 to be flushed. In addition, if the grey water supply pump 19 runs continuously, the flow of grey water to each of the tools of the grey-water processing tools 14A is controlled by individual control valves (not shown). If all of the control valves of the grey-water processing tools 14A are closed simultaneously, a bypass line 23 provides a relief path to permit the grey water supply pump 19 to operate continuously. Specifically, the grey water pump 19 may connect to the collection tank 18 through the return conduit 122R and a valve 122K that provide a relief path or bypass line to permit the pump 19 to operate continuously. Additionally or alternatively, the flush line may be used to allow the grey water pump 19 to run continuously

The grey water loop 16 may include a filter path 20F that permits the loop 16 to be better suited for stone or glass fabrication related to, for example, countertops for residential or commercial use where the specific control of grey water micron size is more critical. The water produced by the filter path 20F may be regarded as filtered grey water, which as used herein is water containing particulate material ranging from 25 to 75 microns in size.

The filter path 20F connects the output of the grey water supply pump 19 and the intake 21 of the grey-water processing tools 14A and may be connected in parallel with the grey water supply line 20 through valves 122A and 122B. The valves 122A and 122B permit the system 10 to more suitably and selectively operate as specified by the particular needs of the stone or glass fabrication shop.

The filter path 20F typically includes a separation filter 120S. The separation filter 120S may be a mechanical separator, such as a centrifugal separator manufactured by Lakos Systems or Yardney Products, to remove relatively large particles, such as particles 75 microns in size or larger, from the water passing therethrough. The separation filter 120S may include a particle outlet 120L to discharge water containing the relatively large particles to the collection tank 18 through a valve 122J. The particles may be removed from the water in the collection tank 18 by other processes that are described in further detail below. The filter path 20F may also include a particle filter 120F that receives water that passes through the separation filter 120S. The particle filter 120F may be, for example, a filter manufactured by Rosedale Products or Yardney Products that removes particles of any appropriate size depending on, for example, the requirements of the grey-water processing tools 14A. Alternatively, the filters 120S and 120F may be combined as a single two-part filter that combines the filtration properties of the individual filters 120S and 120F.

As an alternative, the filter path 20F may be used in place of the grey water supply line 21 and thereby provide the only flow path from the grey water supply pump 19 to the grey-water processing tools 14A. Further still, it is contemplated that some of the grey-water processing tools 14A may receive water directly from the grey water supply pump 19, while other grey-water processing tools 14A simultaneously receive grey water that has been further filtered via the separation filter 120S and/or the particle filter 120F. Hence, different portions of the grey-water processing tools 14A may receive grey water having different levels of particulate.

Referring now to the clear water loop 15, the clear-water processing tools 14B receive clear water from a clear water supply pump 50 through a clear water intake 22 and a clear water supply line 24. Like the grey water supply pump 19, the clear water supply pump 50 may be, for example, a self-priming, electrically powered centrifugal pump that delivers clear water at, for example, 40 psi and at the volume required by the clear-water processing tools 14B, which depends on the specific tools included in the stone processing system. After using the clear water in conjunction with a stone fabrication process, the clear-water processing tools 14B discharge waste water to the collection tank 18 through a waste water discharge port 29.

A filter pump 44 returns water in the collection tank 18 to a clear water tank 48 after the water passes through a high pressure filter 46, such as a filter press. Filter presses are well known in the art, and the filter press 46 may be constructed as described in U.S. Patent Application Publication No. 2008/0190868, the disclosure of which is hereby incorporated by reference. The filter press 46 may also be replaced with a high capacity filter assembly that includes one or more high pressure filter units as described in U.S. Patent Application Publication No. 2008/0190868. The filter pump 44 and the filter press 46 operate to remove most particulate material from the water received from the collection tank 18 and thereby provide clear water to the clear water tank 48. Hence the filter press 46 operates to perform both a filtering and dewatering function.

The filter pump 44 may be operatively connected to the controller 38 to control delivery of water from the collection tank 18 to the clear water tank 48. The controller 38 may also operatively connect to a lower collection tank float sensor 40L to control the operation of the filter pump 44 based on the water level in the collection tank 18. Specifically, the lower collection tank float sensor 40L prevents the filter pump 44 from operating if the water level in the collection tank 18 falls below a threshold. The threshold is typically determined by the height at which a filter pump inlet connects to the collection tank 18.

Still referring to FIG. 1, the clear water tank 48 may include a lower float sensor 52L, a middle float sensor 52M, and an upper float sensor 52U, each of which senses and indicates the water level in the clear water tank 48. For example, the lower float sensor 52L is positioned towards the bottom of the clear water tank 48 and ensures that the clear water supply pump 50 is enabled only when the water level in the clear water tank 48 is at or above the connection of the tank 48 to the pump inlet 23. Similarly, the upper float sensor 52U is located toward the top of the clear water tank 48 and operates to prevent overfilling of the tank 48 by the filter pump 44.

The water level in the clear water tank 48 is between the upper float sensor 52U and the middle float sensor 52M during normal operation of the system 10. If the water level in the clear water tank 42 falls below the middle float sensor 52M, the controller 38 indicates that the system 10 is not operating normally and should be checked and adjusted. The controller 38 is capable thereby of providing a warning of a possible undesirable operating trend, such as the clear water being used by the clear-water processing tools 14B faster than it is being provided from the filter press 46. The controller 38 advantageously provides this warning, such as a visual or auditory warning, before the water level in the clear water tank 48 drops below the lower float sensor 52L.

Like the grey water supply pump 19, the clear water supply pump 50 preferably runs continuously to maintain the desired pressure in the clear water supply line 24 when operation is enabled by the lower float sensor 52L and the controller 38. As a result, the flow of clear water to each of the tools of the clear-water processing tools 14B is controlled by a valve 122E at the outlet of the clear water supply pump 50 and individual control valves (not shown) associated with each tool.

The filter pump 44 may be an air diaphragm pump that is driven by air supplied, for example, at a maximum volume of up to 140 scfm and at a maximum pressure of up to 100 psi. However, it will be recognized that the volume and pressure of the air depends on the desired volume of clear water and the resistance offered by the filter press 46. It will also be recognized that the requirements for the filter pump 44 and the air required to drive the pump 44 depends on the clear water volume requirements of the stone or glass processing system. In addition, the requirements for the filter pump 44 may vary, for example, depending on the effectiveness of the filter press 46, such as the degree to which the filters therein are loaded by filtered particulate material. For example, the filter press 46 may present approximately 5 to 10 psi of backpressure when the filtering apparatus is clean and the filter pump 44 will consume approximately 5 scfm of compressed air. When the filter press 46 is effectively full of particulate material, the filter press 46 will present, for example, approximately 80 psi of backpressure and the filter pump 44 will consume up to 140 scfm of compressed air.

The water recycling system 10 may include a number of conduits and components that continuously clean the water in the collection tank 18 and/or the clear water tank 48. The conduits and components may also prevent the collection tank 18 and/or the clear water tank 48 from reaching capacity or overflowing. These components are described in further detail in the following paragraphs.

Referring to FIG. 1, the water recycling system 10 may include a sterilization loop 54 within the clear water loop 15. The sterilization loop 54 includes the clear water supply pump 50 and a sterilizer 58, such as an ultraviolet disinfection light, that connects to the outlet of the clear water supply pump 50 through a valve 122F. The sterilizer 58 destroys bacteria that may contaminate the water in the clear water tank 48 and returns the clear water to the tank 48. The water in the tank 48 is continuously disinfected with the sterilization loop 54 due to the continuous water flow from the clear water supply pump 50 to the clear-water processing tools 14B. The sterilization loop 54 also provides a relief path for the clear water supply pump 50 if water flow in the clear water supply line 24 is stopped, such as by closing the valves to the clear-water processing tools 14B.

The water recycling system 10 may also include a cleaning loop 55 within the clear water loop 15. The cleaning loop 55 includes the filter pump 44, the filter press 46, and a cleaning water storage tank 118 that connects the outlet of the filter press 46 and the intake of the filter pump 44. Clear water from the cleaning water storage tank 118 may be circulated within the cleaning loop 55 to clean components of the filter press 46. In addition, a pre-coat material may be added to the clear water in the cleaning water storage tank 118 to provide a pre-coat for components of the filter press 46. In these situations, the conduits of the cleaning loop 55 are isolated from the other conduits of the water recycling system 10 by valves 122G and 122H. The cleaning loop 55 may also be operated as described in U.S. Patent Application Publication No. 2008/0190868.

Still referring to FIG. 1, the water recycling system 10 may also include a clear water return conduit 124 that permits water from the filter press 46 to return directly to the waste water collection tank 18. A valve 122C may be included so that water from the filter press 46 may be selectively directed to the collection tank 18 or the clear water tank 48. The clear water return conduit 124 permits water in the collection tank 18 to be continuously filtered without delivering the water to the clear water tank 48. This may be advantageous when there is relatively low demand for water in the clear water tank 48 by the fine processing tools 14B.

The water recycling system 10 may also include a clear water overflow conduit 126 that permits water from the clear water tank 48 to return directly to the collection tank 18. The clear water overflow conduit 126 advantageously connects near the top of the clear water tank 48 and includes a valve 122D to prevent unnecessarily returning clear water to the collection tank 18. The valve 122D also permits continuous operation of the system 10 during start-up operations.

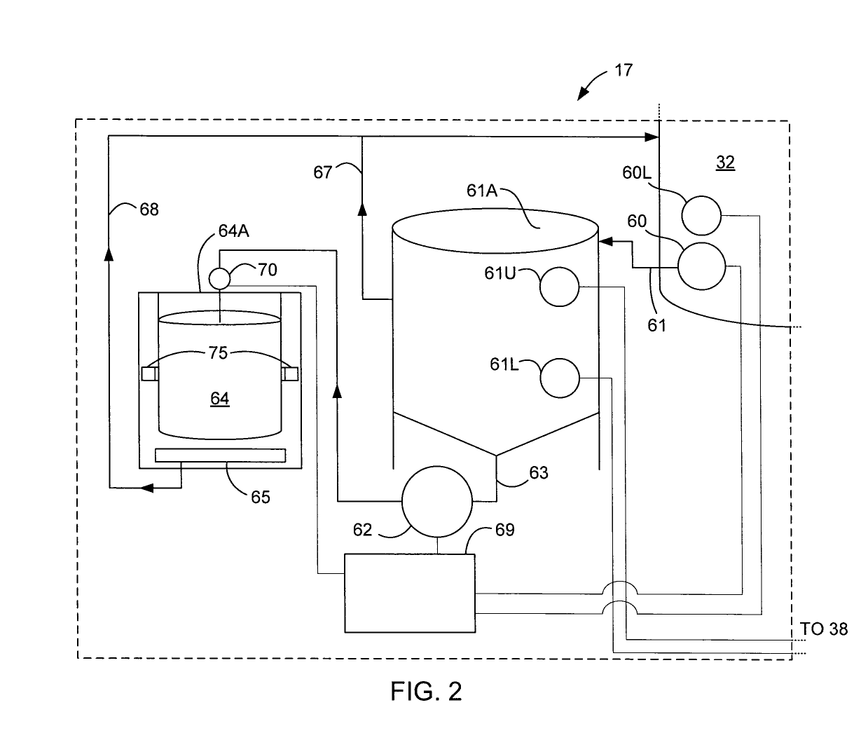

Now referring to FIGS. 1 and 2, the concentrator 17 acts similarly to some gravity settling systems to remove particulate material from the water. The concentrator 17 is supplied with water from the collection tank 18 and returns water to the collection tank 18 after particulate material is removed. The concentrator 17 includes one or more submersible pumps 60 to pump water and particulate material from the collection tank 18 to a storage tank 61A, such as a cone-bottom tank, through a transfer conduit 61. A lower collection tank float sensor 60L that operatively connects to the controller 38 is also located within the collection tank 18. The lower collection tank float sensor 60L prevents the submersible pump 60 from operating if the water level in the collection tank 18 falls below a threshold. The threshold is typically determined by the height of an inlet of the submersible pump 60 within the collection tank 18.

Like the collection and clear water tanks 18 and 48, the storage tank 61A includes upper and lower storage tank float sensors 61U and 61L that operatively connect to the controller 69. The upper storage tank float sensor 61U is positioned near the top of the storage tank 61A to prevent the submersible pump 60 from operating if the water level in the storage tank 61A exceeds a threshold. As a result, the upper storage tank float sensor 61U prevents the submersible pump 60 from overfilling the storage tank 61A. The lower storage tank float sensor 61L is positioned near the bottom of the storage tank 61A to prevent transfer of the particulate material in the storage tank 61A if the particulate level in the storage tank 61A falls below a threshold.

The particulate material is transferred from the storage tank 61A to a containment structure 64A through a plumbing conduit 63 by a concentrator pump 62. Alternatively, the containment structure 64A may be supplied directly from the collection tank 18 by the concentrator pump 62. The concentrator pump 62 may be an air diaphragm pump, such as those manufactured by Warren Rupp, for example, a progressive cavity pump, such as those manufactured by Seepex, for example, used together with an electrically actuated butterfly valve, or other appropriate pumps and valves.

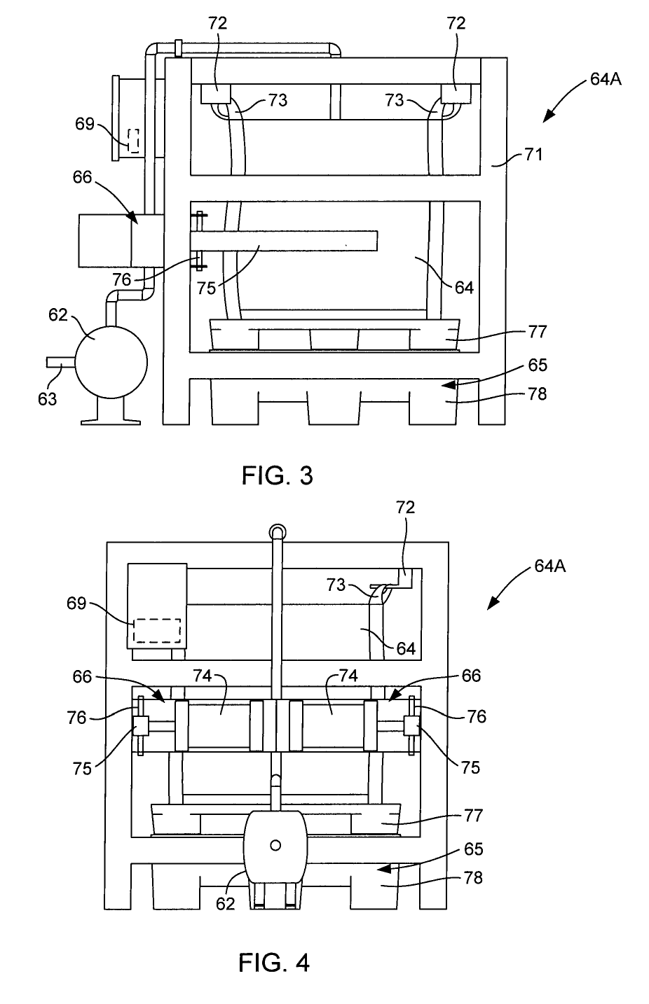

Referring now to FIGS. 3 and 4, the containment structure 64A includes a generally cube-shaped frame 71 that accommodates a high volume compressible filter 64 to which the particulate material is transferred and compression assemblies 66 that periodically engage the high volume compressible filter 64. The frame 71 may be made, for example, from steel square tube stock. The frame 71 includes supports 72 to hold tie straps 73 of the high volume compressible filter 64. The high volume compressible filter 64 may be, for example, a fibered mesh bag with a capacity of, for example, 40 cubic feet per containment structure 64A, such as those manufactured by King Bag with inner bag liners supplied by Clear Edge, Inc. that are rated at various micron and cfm levels based on the particulate to be processed. For example, the bag and liner may have a 70-150 micron rating. The high volume compressible filter 64 advantageously has a recommended minimum capacity of at least 10 cubic feet to permit the system 10 to be serviced relatively infrequently.

The compression assemblies 66 each include an actuator 74 that is periodically actuated to drive a compression arm 75 to engage and squeeze the high volume compressible filter 64. The actuators 74 may be, for example, linear pneumatic actuators. The compression arms 75 move by pivoting about pins 76 and force entrapped water to penetrate through the high volume compressible filter 64. As a result, the particulate material contained in the high volume compressible filter 64 retains relatively little water compared to current bag-type settling systems. In addition, the compression arms 75 may also prevent particulate material from adhering to the sides of the high volume compressible filter 64. The frequency at which the compression arms 75 compress the high volume compressible filter 64 may be selected based on the type of solids to be collected in the high volume compressible filter 64 and the corresponding accumulation of water in the high volume compressible filter 64. For example, the compression arms 75 may operate every 2-3 seconds. The compression arms 75 may be arms such as those manufactured under license, for example, by Water Mark.

Water that penetrates through the high volume compressible filter 64 as the compression arms 75 operate is captured in a containment skid 65 positioned below the high volume compressible filter 64. The containment skid 65 includes a porous upper skid 77 through which water passes and a lower skid 78 that collects water. The upper skid 77 may be removed from the containment structure 64A together with the high volume compressible filter 64 to service the filter 64. Referring again to FIG. 2, the lower skid 78 connects to a drainage conduit 68 to permit water captured in the containment skid 65 to return to the collection tank 18. Similarly, any excess water that accumulates in the storage tank 61A can return to the collection tank 18 through a drain line 67.

During operation of the concentrator 17, the concentrator pump 62 is occasionally disabled, the high volume compressible filter 64 is removed, and a new high volume compressible filter is installed. This process may occur, for example, when the high volume compressible filter 64 is completely filled with solids. The high volume compressible filter 64 may be removed from the containment structure 64A using a lift system (not shown), such as a fork lift. Alternatively, the high volume compressible filter 64 may include several clips near a bottom opening that are removed to release the contents of the filter 64. After a new high volume compressible filter 64 has been installed or the particulate material has been released, operation of the concentrator pump 62 resumes and the high volume compressible filter 64 begins to fill with solids.

Referring again to FIGS. 1 and 2, the concentrator 17 may include a controller 69 that controls the concentrator pump 62 based on a signal from an ultrasonic liquid level sensor 70 positioned above the containment structure 64A. Specifically, the controller 69 may disable operation of the concentrator pump 62 if the ultrasonic liquid level sensor 70 indicates that the high volume compressible filter 64 is completely filled with solids. In addition, the controller 69 may provide a notification that the high volume compressible filter 64 is completely filled with solids, such as an audible and/or visual alarm. The controller 69 may be, for example, a programmable logic controller (PLC) such as those manufactured by Schneider Electric under model #SR2A201BD.

The concentrator 17 removes solids in parallel with operation of the grey water loop 16 and the clear water loop 15, and all three loops draw water from the same source. Larger quantities of solids can be removed from the collection tank 18 by permitting the concentrator 17 to operate continuously. Continuous operation of the concentrator 17 advantageously reduces the load on the filter press 46 by providing the filter press 46 with grey water that is more appropriate for recycling into clear water. The reduced load on the filter press 46 increases operating time between filter press 46 service points. Depending on the quantity of solids being removed, the high volume compressible filter 64 may be emptied every day, every few days, weekly, bi-weekly or even monthly. In addition, the high volume compressible filter 64 can be serviced quickly relative to the filter press 46. For example, less than five minutes may be required to remove the high volume compressible filter 64 from the containment structure 64A. Considering the frequency and time required to service filter presses in current systems as described above, the concentrator 17 may provide a savings of up to 16 man-hours per week or more for larger filter presses with daily service points. This savings results in 16 hours that could be spent in other areas. Furthermore, the concentrator 17 reduces the need for a larger filter press 46 or additional filter presses, which is a significant cost reduction.

As briefly described above, the water recycling system 10 of the present invention may also be used with a glass processing system, even though the disclosure primarily discusses the system 10 as used with a stone processing system. Those skilled in the art will recognize minor modifications to provide a system that is especially suitable for glass processing.

The concentrator 17 may be used separately from the grey and clear water loops 16 and 15 as a stand-alone filtration system dedicated to one or more pieces of fabrication equipment. For example, the concentrator 17 may be used separately to filter particulate from the collecting tables located beneath water/saw jet equipment.

Since certain changes may be made in the above described method and system without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. A system for recycling water driving industrial fabrication equipment including at least clear water tools, the system comprising:
a collection tank connected to receive waste water discharged by industrial fabrication equipment;
a high volume compressible filter connected to receive waste water from the collection tank and permit at least some of the waste water to pass therethrough to remove a portion of particulate from the waste water;
at least one compression arm configured to engage the high volume compressible filter to agitate the waste water within the high volume compressible filter and force waste water from the high volume compressible filter;
a clear water supply loop, including:
a high pressure filter connected to receive the waste water from the collection tank and convert the waste water to the clear water;
a clear water tank connected to receive and store the clear water from the high pressure filter; and
a clear water supply pump connected to receive the clear water from the clear water tank and provide the clear water to the industrial fabrication equipment.

2. The water recycling system of claim 1, wherein the concentrator further includes a concentrator pump connected to receive the waste water from the collection tank and provide the waste water to the high volume compressible filter.

3. The water recycling system of claim 2, further comprising a controller operatively connected to the concentrator pump to control operation of the concentrator pump, and the concentrator further including a liquid level sensor operatively connected to the controller to indicate if the high volume compressible filter is completely filled with the particulate material.

4. The water recycling system of claim 1, wherein the concentrator further includes:
a containment skid to collect the waste water that passes through the high volume compressible filter; and
a drainage conduit connected to receive the waste water from the containment skid and return the waste water to the collection tank.

5. The water recycling system of claim 1, wherein the at least one compression arm is pivotable to engage the high volume compressible filter.

6. The water recycling system of claim 1, wherein the concentrator further comprises a pneumatic actuator to drive the at least one compression arm.

7. The water recycling system of claim 1, wherein the containment structure is configured to accommodate the high volume compressible filter such that the high volume compressible filter has a volume of at least 10 cubic feet.

8. The water recycling system of claim 1, wherein the high volume compressible filter is a fibered mesh bag.

9. The water recycling system of claim 1, further comprising a grey water supply loop including a grey water supply pump connected to receive the waste water from the collection tank and provide the waste water to grey water tools of the industrial fabrication equipment.

10. A water recycling system having a grey water loop supplying water to grey-water processing tools and a clear water loop supplying water to clear-water processing tools, the system comprising:
a collection tank connected to receive waste water discharged from the grey-water and clear-water processing tools;
a clear water tank connected to supply clear water to the clear-water processing tools;
a filter press connected to receive waste water from the collection tank and configured to convert the waste water to clear water and connected to supply clear water to the clear water tank;
a grey water supply line connected to provide waste water from the collection tank to the grey-water processing tools, and the grey water supply line connected in parallel relative to the filter press;
a concentrator connected to receive waste water from the collection tank and configured to accommodate a high volume compressible filter configured to remove particulate material from the waste water, and the concentrator connected in parallel relative to the filter press; and
a drainage conduit connected to return water from the concentrator to the collection tank after removing the particulate material from the waste water.

11. The water recycling system of claim 10, wherein the concentrator is configured to accommodate the high volume compressible filter such that the high volume compressible filter has a volume of at least 10 cubic feet.

12. The water recycling system of claim 10, wherein the concentrator includes:
a containment structure configured to accommodate the high volume compressible filter; and
at least one compression arm configured to engage the high volume compressible filter and force at least some of the waste water to pass through the high volume compressible filter.

13. The water recycling system of claim 12, wherein the concentrator includes a plurality of compression arms configured to engage opposite sides of the high volume compressible filter.

14. The water recycling system of claim 13, wherein each of the plurality of compression arms connects to a pneumatic actuator that drives each of the plurality of compression arms.

15. The water recycling system of claim 10, wherein the concentrator includes:
a cone-bottom tank connected to receive waste water from the collection tank; and
a concentrator pump connected to draw waste water from the cone-bottom tank and supply waste water to the high volume compressible filter.

16. The water recycling system of claim 15, wherein the concentrator further includes a submersible pump within the collection tank to supply waste water to the cone-bottom tank.

17. A method of providing clear water to processing tools, comprising the steps of:
receiving and storing waste water from waste water discharge ports of the processing tools in a collection tank;
filtering the waste water from the collection tank in a high pressure filter to produce clear water;
receiving and storing the clear water from the high pressure filter in a clear water tank;
providing the clear water from the clear water tank to the processing tools through a clear water supply pump;
filtering the waste water from the collection tank in parallel relative to the high pressure filter in a high volume compressible filter to remove particulate material;
compressing the high volume compressible filter to force water to pass through the high volume compressible filter; and
returning water to the collection tank after removing particulate material with the high volume compressible filter.

18. The method of providing clear water to processing tools of claim 17, further comprising compressing the high volume compressible filter periodically.

19. The method of providing clear water to processing tools of claim 17, further comprising the step of disabling a concentrator pump that provides waste water to the high volume compressible filter if the high volume compressible filter is completely filled with particulate matter.

20. The method of providing clear water to processing tools of claim 17, further comprising the steps of:
providing the clear water from the clear water tank to clear processing tools through the clear water supply pump; and
providing grey water from the collection tank to grey water processing tools through a grey water supply line.

21. The method of providing clear water to processing tools of claim 17, further comprising the step of storing the waste water in a cone-bottom tank before filtering the waste water in the high volume compressible filter.

22. A concentrator for removing particulate matter from waste water, comprising:
a frame;
a high volume compressible filter supported by the frame, and the high volume compressible filter being connected to receive the waste water and permit at least some of the waste water to pass therethrough to remove a portion of the particulate from the waste water; and
at least one compression arm connected to the frame and configured to engage the high volume compressible filter to agitate the waste water within the high volume compressible filter and force waste water from the high volume compressible filter.

23. The concentrator of claim 22, wherein the at least one compression arm pivots relative to the frame to engage the high volume compressible filter.

24. The concentrator of claim 22, further comprising a plurality of compression arms configured to engage opposite sides of the high volume compressible filter.

25. The concentrator of claim 22, further comprising a containment skid configured to collect the waste water that passes through the high volume compressible filter.

26. The concentrator of claim 22, wherein the supports hold tie straps of the high volume compressible filter.

27. The concentrator of claim 22, further comprising:
a pump to provide waste water to the high volume compressible filter;
a sensor configured to indicate if the high volume compressible filter is completely filled with particulate; and
a controller operatively connected to the pump and the sensor, and the controller disabling the pump if the sensor indicates the high volume compressible filter is completely filled with particulate.
